(19) United States
(12) Patent Application Publication
(10) Pub. No.: US 2026/0338924 A1
(43) Pub. Date: Oct. 29, 2026

(54) LIDAR

(71) Applicant: AUTOX TECH PTE. LTD., SINGAPORE (SG)

(72) Inventors: Yizhou Shan, Shenzhen (CN); Jianxiong Xiao, Shenzhen (CN); Kefan Hu, Shenzhen (CN); Xuhui Tao, Shenzhen (CN); Wenxiang Wang, Shenzhen (CN)

(73) Assignee: AUTOX TECH PTE. LTD., SINGAPORE (SG)

(21) Appl. No.: 19/193,893

(22) Filed: Apr. 29, 2025

(51) Int. Cl. G01S 7/481; G01S 17/931

(52) U.S. Cl. CPC G01S 7/4817; G01S 7/4813; G01S 7/4818; G01S 17/931

(57) ABSTRACT

The disclosure provides a LiDAR device, including an upper housing with a window; a lower housing opposite the upper housing; a connecting neck between the housings; an optical path through the lower housing, neck, and upper housing; a laser transceiver assembly in the lower housing; a reflective assembly in the upper housing with a reflector and self-rotation controller; a control assembly with a turntable controller in the lower housing and a turntable connected to it, extending into the upper housing to mount the reflector; wherein: the turntable rotates about a first axis; the self-rotation controller flips the reflector about a second axis distinct from the first; the laser transceiver emits planar-parallel beams that: travel via the optical path to the reflector, reflect through the window, return as reflected beams via the reflector and optical path to the laser transceiver.

### TECHNICAL FIELD

The disclosure relates to the field of LiDAR technology, and more particularly, to a LiDAR.

### BACKGROUND

The essence of laser three-dimensional imaging lies in parallel laser ranging, which obtains the target's range image by directly or indirectly measuring the time difference between the laser emission signal and the echo signal. Scanning laser radar systems are composed of single-point laser coherent or incoherent ranging systems equipped with beam scanning devices, representing a relatively mature three-dimensional imaging laser radar technology. These systems require rapid ranging for each point, with beam scanning devices controlling the radar optical axis to point in different directions, sequentially measuring the distance of each point on the target while recording the azimuth-elevation angles of the beam direction. This process enables the acquisition of the target's range-angle-angle image.

Vehicle-mounted laser radars that provide necessary 3D point cloud data for autonomous vehicles typically require a 360° horizontal field of view (FOV) and a specific vertical FOV. Scanning laser radars achieve beam deflection through motor-driven mirror rotation and geometrical optics principles, featuring large scanning fields and high scanning efficiency. This makes them the most common, widely applied, and mature vehicle-mounted laser radar technology in recent years. The “mechanical rotation+linear transceiver array” configuration is a typical representative of this scanning method: Horizontal mechanical rotation achieves 360° FOV, while vertical multi-line scanning is formed through linear array arrangements of laser transceiver modules matched with parallel detection modules. Specific angular intervals between scanning lines enable uniform or non-uniform angular coverage in the linear array direction. This scanning method reduces motion complexity in one dimension, requiring scanning along only one axis to obtain target range images, significantly improving system scanning efficiency. However, this solution demands high-frequency laser emitters densely arranged in the vertical direction within the radar's upper housing structure, with precise alignment of optical modules across emission and reception channels. Cross-talk between ranging channels imposes stringent assembly precision requirements, resulting in large overall dimensions, high rotational inertia, significant power consumption, and elevated costs for the scanning laser radar. Additionally, demands for thermal dissipation and manufacturing processes are substantially increased.

### SUMMARY

The disclosure provides a LiDAR that resolves issues associated with conventional scanning LiDARs, including large overall dimensions, high moment of inertia, high power consumption, and high manufacturing costs.

An embodiment of the disclosure provides a LiDAR including: an upper housing; and a lower housing, opposite to the upper housing; a connecting neck, connected between the upper housing and the lower housing; and an optical path, communicated with the lower housing, the connecting neck, and the upper housing; wherein a laser transceiver assembly is arranged inside the lower housing, a reflective assembly is arranged inside the upper housing; the reflective assembly includes a reflector, and a self-rotation controller; the upper housing includes a window; the LiDAR device further includes a control assembly, the control assembly includes a turntable controller, and a turntable, the turntable controller is fixed inside the lower housing, one end of the turntable is connected to the turntable controller, and the other end extends into the upper housing for mounting the reflector; wherein the turntable controller controls the turntable to rotate about a first axis, and the self-rotation controller is configured to drive the reflector to flip about a second axis different from the direction of the first axis, on the turntable, so that the reflector rotating about the first axis simultaneously flips about the second axis; wherein the laser transceiver assembly is configured to emit a plurality of laser beams parallel in a plane, the plurality of laser beams transmits along the optical path into the reflector in the upper housing, and the plurality of laser beams are reflected by the reflector to exit through the window; after being emitted, the plurality of laser beams form a plurality of reflected beams upon reflection by an object, the reflected beams then return through the window to the reflector, and the plurality of reflected beams are reflected by the reflector to travel back along the optical path to the laser transceiver assembly.

In the aforementioned LiDAR, when the laser beams are incident on the reflective element, the reflective element simultaneously rotates about the first axis and flips about the second axis, reflecting the laser beams along both axes to achieve multi-line scanning. When the reflective element completes a full 360° rotation about the first axis while simultaneously undergoing a full 360° flip about the second axis, it enables 360° circumferential scanning to generate a 360° point cloud array. The integrated structure of this LiDAR breaks conventional constraints of multi-line LiDAR configurations, enabling compatibility with various LiDAR architectures including incoherent and coherent systems. The system features low moment of inertia, simple structure, high reliability, and ease of miniaturized integration, demonstrating promising development potential in vehicular LiDAR applications.

### BRIEF DESCRIPTION OF THE DRAWINGS

To more clearly illustrate the technical solutions in the embodiments of the disclosure or in the prior art, the following provides a brief introduction to the drawings required for describing the embodiments or the prior art. It is apparent that the drawings described below are merely some embodiments of the disclosure. For those skilled in the art, other drawings can be obtained based on the structures shown in these drawings without exercising inventive effort.

FIG. 1 is a schematic diagram of a LiDAR in accordance with an embodiment.

FIG. 2 is an internal structural schematic diagram of the LiDAR in accordance with an embodiment.

FIG. 3 is an internal structural schematic diagram of the laser transceiver assembly of the LiDAR shown in FIG. 1.

FIG. 4 is a schematic diagram of the laser transceiver assembly of the LiDAR shown in FIG. 1.

FIG. 5 is an internal structural schematic diagram of the reflection assembly of the LiDAR shown in FIG. 1.

FIG. 6 is a cross-sectional schematic diagram of the reflective element of the LiDAR shown in FIG. 1.

FIG. 7 is an internal structural schematic diagram of the processing component of the LiDAR shown in FIG. 1.

FIG. 8 is a connection diagram between the processing component and the laser transceiver assembly of the LiDAR shown in FIG. 1.

The realization of the objectives, functional features, and advantages of the disclosure will be further described below with reference to the embodiments and the accompanying drawings.

### DETAILED DESCRIPTION OF THE EMBODIMENTS

In order to make the purpose, technical solution, and advantages of this application clearer and clearer, the following will provide further detailed explanations of this application in conjunction with the accompanying drawings and embodiments. It should be understood that the specific embodiments described here are only intended to explain the present application and are not intended to limit the present application. Based on the embodiments in this application, all other embodiments obtained by ordinary technical personnel in this field without creative labor fall within the scope of protection of this application.

The terms “first,” “second,” “third,” “fourth,” etc. (if present) in the specification, claims, and accompanying drawings of the present application are used to distinguish similar planning objects and are not necessarily used to describe a specific sequence or order. It should be understood that such terms, when used, may be interchangeable under appropriate circumstances. In other words, the described embodiments may be implemented in an order other than that illustrated or described herein. Furthermore, the terms “include” and “have” and any variations thereof may also encompass additional content. For example, a process, method, system, product, or device including a series of steps or units is not limited to only those steps or units clearly listed but may include other steps or units not clearly listed or inherent to those processes, methods, products, or device.

It is important to note that the descriptions involving “first,” “second,” etc., in the present application are solely for descriptive purposes and should not be understood as indicating or implying their relative importance or implicitly specifying the number of indicated technical features. Therefore, features qualified by “first,” “second,” etc., may explicitly or implicitly include one or more of such features. In addition, the technical solutions among the various embodiments may be combined with each other, but this must be based on the ability of ordinary skilled artisans in the field to achieve such combinations. When the combination of technical solutions contradicts each other or cannot be implemented, such combinations should be deemed non-existent and not within the scope of protection claimed in the present application.

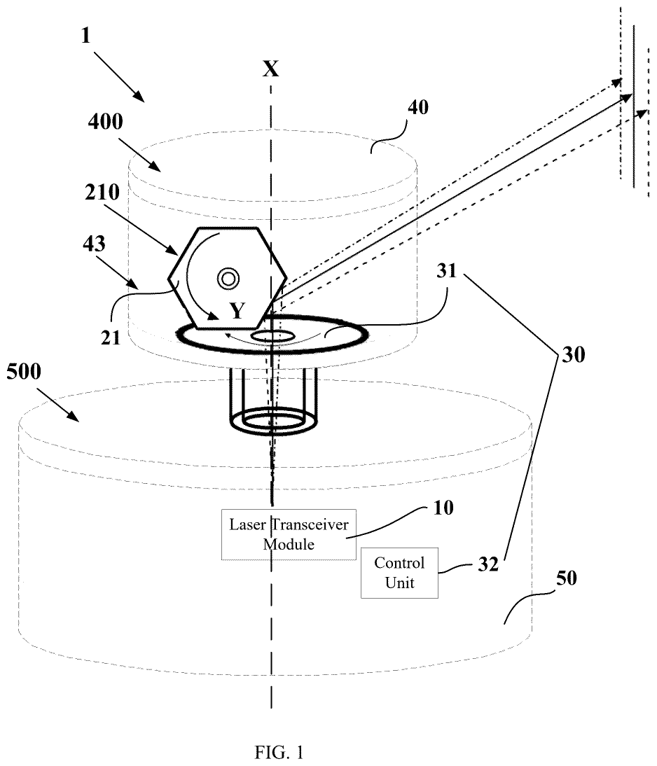

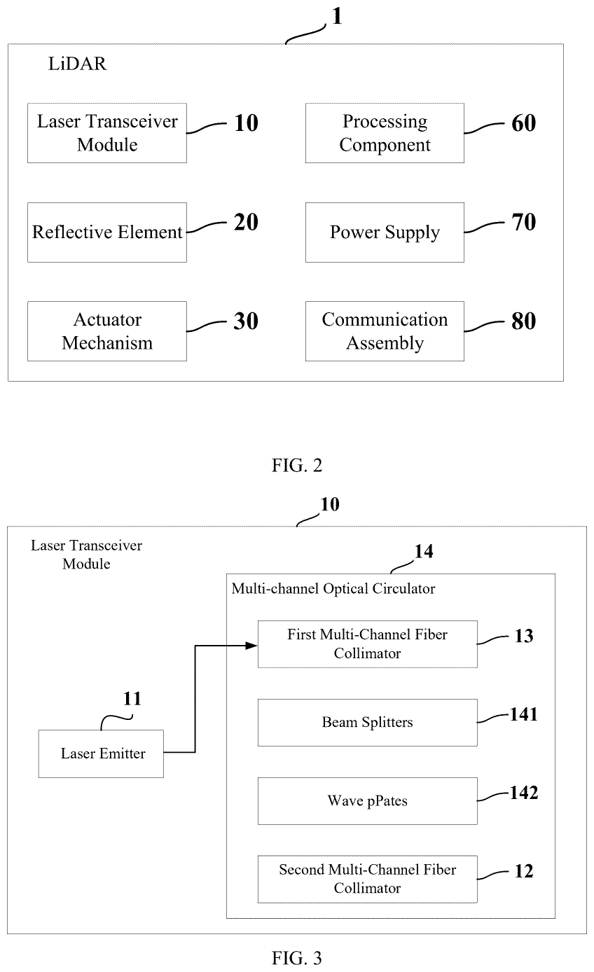

Referring to FIGS. 1 to 3. FIG. 1 is a schematic diagram of a LiDAR in accordance with an embodiment, FIG. 2 is an internal structural schematic diagram of the LiDAR in accordance with an embodiment, and FIG. 3 is a schematic diagram of a laser transceiver assembly in accordance with an embodiment. The LiDAR 1 includes an upper housing 40, a lower housing 50, a connecting neck 90, and an optical path 100. In this embodiment, the upper housing 40 and the lower housing 50 are disposed opposite to each other, and the connecting neck 90 connects the upper housing 40 and the lower housing 50 and is located therebetween. The optical path 100 connects the upper housing 40, the connecting neck 90, and the lower housing 50. The LiDAR 1 further includes a laser transceiver assembly 10, a reflection assembly 20, and a control assembly 30. The laser transceiver assembly 10 is disposed inside the lower housing 50, and the reflection assembly 20 is disposed inside the upper housing 40.

Furthermore, the upper housing 40, the lower housing 50, and the connecting neck 90 respectively includes a cylindrical first shell 41, a second shell 51, and a third shell 91. The central axes of the first shell 41, the second shell 51, and the third shell 91 all coincide. That is, the upper housing 40, the lower housing 50, and the connecting neck 90 are all cylindrical. In this embodiment, diameters of the first shell 41 and the second shell 51 are substantially the same and larger than that of the connecting neck 91, and the overall shape of the LiDAR 1 is substantially I-shaped.

The upper housing 40 is provided with a window 43. The window 43 is disposed on a side surface of the first shell 41. Furthermore, the window 43 is an annular window. Specifically, in this embodiment, the first shell 41 and the second shell 51 are spaced apart along a first axis X and fixedly connected via the connecting neck 90. The first shell 41 defines a first accommodation cavity 400, and the second shell 51 defines a second accommodation cavity 500, with the first accommodation cavity 400 and the second accommodation cavity 500 being in communication. It can be understood that the optical path 100 passes through the first accommodation cavity 400 and the second accommodation cavity 500, and the axis of the first shell 41, the axis of the second shell 51, and the first axis X are parallel.

The laser transceiver assembly 10 is configured to emit a plurality of laser beams and receive a plurality of reflected beams formed by reflection of the laser beams from an object. The plurality of laser beams are located in a plane. That is, the plurality of laser beams are arranged in a linear array.

The reflection assembly 20 includes a reflective element 21. The plurality of laser beams enter the reflective element 21 of the upper housing 40 along the optical path 100, and after being reflected by the reflective element 21, the laser beams exit from the window 43 to the outside of the LiDAR 1. The reflected beams formed after the laser beams exit pass through the window 43 and return to the reflective element 21, and after being reflected by the reflective element 21, the reflected beams travel back along the optical path to the laser transceiver assembly 10 and are received thereby. In this embodiment, there is a certain angle between adjacent laser beams among the plurality of laser beams.

In this embodiment, the laser transceiver assembly 10 is accommodated in the second accommodation cavity 500 and includes a laser emitter 11, and a multi-channel optical circulator 14. The laser emitter 11 serves as a laser emission source and can emit frequency-modulated continuous wave lasers or pulsed wave lasers. The multi-channel optical circulator 14 includes a first multi-channel fiber collimator 13 and a second multi-channel fiber collimator 12. A number of channels of the first multi-channel fiber collimator 13 is the same as a number of channels of the second multi-channel fiber collimator 12. The laser emitter 11 is connected to the first multi-channel fiber collimator 13, and the original beam emitted by the laser emitter 11 passes through the first multi-channel fiber collimator 13 to form the plurality of laser beams. There is an angle between adjacent laser beams among the plurality of laser beams, and the magnitude of the angle can be adjusted according to the spot size and overlap degree of the laser beams. The number of laser beams in the plurality of laser beams is the same as the number of channels of the first multi-channel fiber collimator 13. The multi-channel optical circulator 14 forms a plurality of transmitting channels and a plurality of receiving channels. The plurality of laser beams enter the reflective element 21 along the transmitting channels, and the plurality of reflected beams enter the second multi-channel fiber collimator 12 along the receiving channels. The number of transmitting channels is the same as the number of receiving channels, and the transmitting channels and receiving channels correspond one-to-one. It can be understood that the first multi-channel fiber collimator 13 is used to emit the plurality of laser beams, and the second multi-channel fiber collimator 12 is used to receive the plurality of reflected beams. The number of laser beams, the number of reflected beams, the number of transmitting channels, and the number of receiving channels are all the same, and the laser beams correspond to the transmitting channels one-to-one, and the reflected beams correspond to the receiving channels one-to-one.

The multi-channel optical circulator 14 further includes a plurality of beam splitters 141 and a plurality of wave plates 142. The plurality of beam splitters 141 and the plurality of wave plates 142 are arranged in a certain arrangement between the first multi-channel fiber collimator 13 and the second multi-channel fiber collimator 12 to form the plurality of transmitting channels and the plurality of receiving channels. In this embodiment, each transmitting channel and the corresponding receiving channel partially overlap. That is, the transmitting channels and receiving channels are co-axial for transmitting and receiving, thereby achieving matching between the transmitting channels and receiving channels. The beam splitters 141 include but are not limited to polarization beam splitters, non-polarization beam splitters, etc., and the wave plates 142 include but are not limited to half-wave plates, quarter-wave plates, etc. The types of beam splitters 141 and wave plates 142, as well as their arrangement, can be set according to the number of laser beams and are not limited herein.

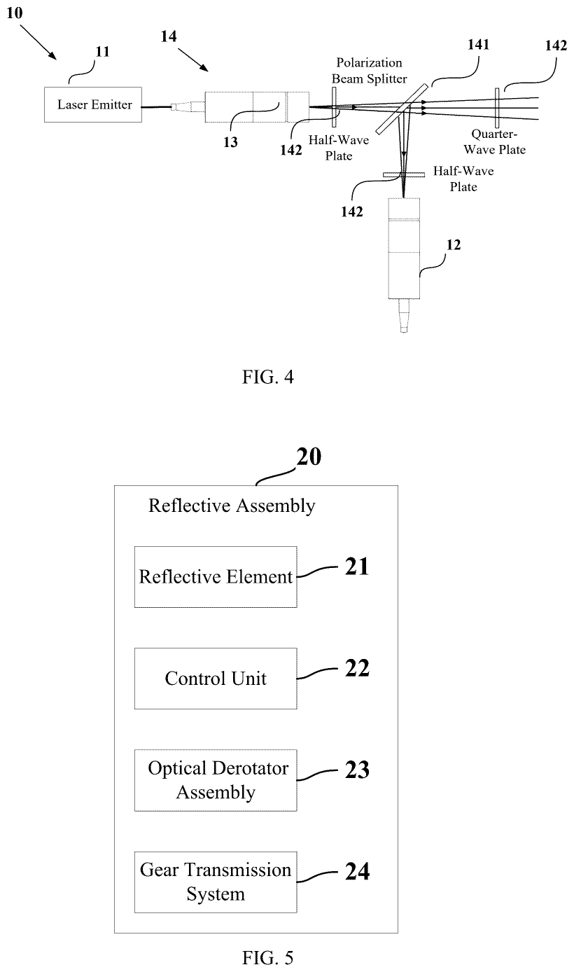

Taking the laser transceiver assembly 10 shown in FIG. 4 as an example, both the first multi-channel fiber collimator 13 and the second multi-channel fiber collimator 12 are three-channel fiber collimators and are disposed perpendicular to each other. The original beam emitted by the laser emitter 11 is a frequency-modulated continuous wave with a wavelength band of 1550 nm. The original beam passes through the first multi-channel fiber collimator 13 to form three laser beams, and the degree of polarization of the three laser beams is greater than 20 dB. The three laser beams are in the same plane, the diameter of each laser beam is 10 mm, and the angle between adjacent laser beams among the three laser beams is 0.2°. Specifically, the laser beam in the first channel is deflected by +0.2°, the laser beam in the second channel is deflected by 0°, and the laser beam in the third channel is deflected by −0.2°. Although there is a certain angle between adjacent laser beams among the laser beams, since the angle can be adjusted according to the density of the laser beams and is typically between 0.1° and 0.2°, it does not have a significant impact on the polarization performance of the multi-channel optical circulator 14.

The multi-channel optical circulator 14 includes a polarization beam splitter (PBS), two half-wave plates, and a quarter-wave plate. The two half-wave plates respectively correspond to first multi-channel fiber collimator 13 and second multi-channel fiber collimator 12. The two half-wave plates are respectively disposed at the exit port of first multi-channel fiber collimator 13 and the entrance port of second multi-channel fiber collimator 12. The polarization beam splitter is disposed at the intersection of the straight line where the first multi-channel fiber collimator 13 is located, and the straight line where second multi-channel fiber collimator 12 is located. The quarter-wave plate is disposed on the side of the polarization beam splitter away from first multi-channel fiber collimator 13. It is understood that first multi-channel fiber collimator 13, the half-wave plate corresponding to first multi-channel fiber collimator 13, the polarization beam splitter, and the quarter-wave plate are positioned collinearly and sequentially arranged along a first axis X. The polarization beam splitter, the half-wave plate corresponding to second multi-channel fiber collimator 12, and second multi-channel fiber collimator 12 are positioned collinearly and sequentially arranged along a direction perpendicular to the first axis X. In this embodiment, moving away from first housing 41, the quarter-wave plate, polarization beam splitter, the half-wave plate corresponding to first multi-channel fiber collimator 13, and first multi-channel fiber collimator 13 are sequentially arranged along the first axis X. Moving away from the polarization beam splitter, the half-wave plate corresponding to second multi-channel fiber collimator 12 and second multi-channel fiber collimator 12 are sequentially arranged along the direction perpendicular to the first axis X. Three emission channels are formed between first multi-channel fiber collimator 13, the half-wave plate corresponding to first multi-channel fiber collimator 13, the polarization beam splitter, and the quarter-wave plate. Three reception channels are formed between the quarter-wave plate, the polarization beam splitter, the half-wave plate corresponding to second multi-channel fiber collimator 12, and second multi-channel fiber collimator 12. It is understood that each emission channel and its corresponding reception channel partially overlap between the quarter-wave plate and the polarization beam splitter.

Three laser beams emitted from first multi-channel fiber collimator 13 first pass through the half-wave plate corresponding to first multi-channel fiber collimator 13, then pass through the polarization beam splitter, and exit from the quarter-wave plate. Three parallel reflected beams enter from the quarter-wave plate, and their polarization states are rotated to vertical polarization by rotating the quarter-wave plate, then sequentially pass through the polarization beam splitter and the half-wave plate corresponding to second multi-channel fiber collimator 12, and enter second multi-channel fiber collimator 12.

The polarization beam splitter has a diameter of 12.7 mm and a thickness of 2 mm, with a design wavelength of 1550 nm, dimensional tolerance of ±0.1 mm, surface quality of 60/40, light transmission aperture greater than 80%, transmitted wavefront distortion and reflected wavefront distortion both not exceeding λ/8@633 nm, beam deviation less than 0.5 minutes, transmission extinction ratio greater than 1000:1, reflection extinction ratio greater than 200:1, the splitting surface is coated with a 1550 nm polarization beam splitting dielectric film (PBS), and the incident surface is coated with a 1550 nm anti-reflective film, R<0.25%@1550 nm. In some feasible embodiments, parameters of the polarization beam splitter can be adjusted based on actual conditions and are not limited thereto.

In this embodiment, the control assembly 30 includes electrically connected rotary table 31 and rotary table controller 32. Rotary table controller 32 is fixed inside lower compartment 50, one end of rotary table 31 is connected to rotary table controller 32, and the other end of rotary table 31 extends into upper housing 40 for the mounting reflective element 21. That is, the rotary table controller 32 is accommodated in the second accommodation cavity 500, one end of the rotary table 31 is connected to the rotary table controller 32, and the other end of the rotary table 31 protrudes into the first accommodation cavity 400. The reflective assembly 20 is fixed to the rotary table 31, and the rotary table controller 32 is configured to control the rotary table 31 to rotate around the first axis X. The rotation directions include clockwise and counterclockwise. It is understood that since the reflective assembly 20 is fixed to the rotary table 31, when the rotary table controller 32 controls the rotary table 31 to rotate around the first axis X, the reflective assembly 20 rotates with the rotary table 31.

In this embodiment, the first axis X is the central axis of rotary table 31. The rotary table 31 includes a rotating shaft 311 and a turntable 312, with the rotating shaft 311 connecting the rotary table controller 32 and the turntable 312. The rotating shaft 311 is in the shape of a hollow cylinder, and the first axis X is the central axis of the rotating shaft 311. The reflective assembly 20 is disposed on the side of the turntable 312 away from the rotary table controller 32. Furthermore, the first axis X coincides with the central axis of first housing 41, the central axis of the second housing 51, and the central axis of third housing 91. In this embodiment, the rotary table controller 32 can control the rotary table 31 to rotate 360° around the first axis X, enabling the LiDAR 1 to achieve 360° circumferential linear array laser scanning. Herein, the rotation speed of the rotary table 31 controlled by rotary table controller 32 to rotate around the first axis X is a first rotation speed, which can be set according to actual application scenarios. The higher the first rotation speed of the rotary table 31, the faster the perception speed of the LiDAR 1 to the external environment.

The reflective assembly 20 is accommodated in the first accommodation cavity 400 and further includes a self-rotation controller 22. The reflective element 21 is mounted on rotary table 31, and the self-rotation controller 22 is configured to drive the reflective element 21 to flip around a second axis Y different from the direction of the first axis X on the rotary table 31. It is understood that the reflective element 21 can rotate with the rotary table 31, and the entire reflective element 21 can also flip around the second axis Y, with the rotation speed around the first axis X being the same as the first rotation speed of the rotary table 31. Therefore, the lective element 21 can flip around the second axis Y while rotating around the first axis X. Flip directions include clockwise and counterclockwise. Furthermore, the self-rotation controller 22 controls the reflective element 21 to perform 360° flipping around the second axis Y. Herein, the flip speed of reflective element 21 controlled by the self-rotation controller 22 to flip around the second axis Y is a second rotation speed, which can be set according to actual application scenarios. The higher the second rotation speed of the reflective element 21, the faster the perception speed of the LiDAR 1 to the external environment.

An angle exists between the second axis Y and the first axis X, and the angle size can be set based on actual conditions. In this embodiment, the first axis X and the second axis Y are perpendicular to each other, i.e., the angle is 90°.

The reflective element 21 is a prismatic body or a pyramidal body. In this embodiment, The reflective element 21 is a regular prismatic body, and the second axis Y is the central axis of reflective element 21. It is understood that when reflective element 21 rotates around the first axis X, the second axis Y rotates with the rotation of reflective element 21. That is, the second axis Y is not fixed. The regular prismatic bodies include but are not limited to regular hexagonal prisms, regular octagonal prisms, etc. In some feasible embodiments, the reflective element 21 can also be a pyramidal body. Regardless of whether the reflective element 21 is a regular prismatic body or a pyramidal body, all side surfaces of the reflective element 21 are reflective mirrors, and the side surfaces of the reflective element 21 can reflect light beams to deflect the light beams. Only disposing the reflective assembly 20 in first accommodation cavity 400 can reduce the overall weight of components placed in first accommodation cavity 400, making the rotary table 31 lighter in weight during rotation and more agile. Simultaneously, it can also reduce adverse effects such as vibration and displacement of components caused by the rotation of rotary table 31.

The reflective element 21 includes a plurality of reflective surfaces 210, with the plurality of the reflective surfaces 210 being adjacent to each other around the second axis Y. A plurality of the laser beams propagate from the second accommodation cavity 500 to the first accommodation cavity 400 along a plurality of the emission channels and enter the reflective element 21, and the reflective surfaces 210 reflect the plurality of the laser beams to enable the laser beams to exit from the window 43. When the reflected beams enter the reflective element 21 from the window 43, the reflective surfaces 210 are further configured to reflect the reflected beams to enable the reflected beams to propagate from the first accommodation cavity 400 to the second accommodation cavity 500 and be received by the laser transceiver assembly 10. When the plurality of the laser beams enter reflective element 21, the plane where the plurality of the laser beams are located is parallel to the first axis X. The reflective element 21 can rotate around the first axis X while flipping around the second axis Y to reflect the laser beams, thereby forming a point cloud array.

When the reflective element 21 rotates around the first axis X, it reflects laser beams to enable the laser beams to form a plurality of the first scanning lines around the first axis X. When the reflective element 21 flips around the second axis Y, it reflects laser beams to enable the laser beams to form a plurality of the second scanning lines around the second axis Y. The plurality of the first scanning lines and the plurality of the second scanning lines jointly form a point cloud array. It is understood that the first scanning lines formed by the laser beams are perpendicular to the first axis X, and the second scanning lines formed by the laser beams are perpendicular to the second axis Y.

The scanning frequency of the reflective element 21 can be calculated based on a first formula. Specifically, the first formula is: f_{scan}=ω̅Nₘ.

Wherein, f_{scan} represents the scanning frequency, ω̅ represents the second rotational speed, and Nₘ represents the number of reflective surfaces 210. In this embodiment, ω̅ refers to the number of revolutions of the reflective element 21 rotating 360° around the second axis Y in 1 second, and f_{scan} refers to the equivalent revolutions of the reflective element 21 rotating 360° around the second axis Y in 1 second. For example, when ω̅ is 100 revolutions/second and Nₘ is 8, it is equivalent to the reflective element 21 rotating 800 revolutions in 1 second.

The number of scan lines per frame of the LiDAR 1 can be calculated based on a second formula. Specifically, the second formula is:

$${N}_{p} = \frac{{f}_{s c a n}}{{f}_{FRAME}} = \frac{ϖ {N}_{m}}{{f}_{FRAME}} .$$

Wherein, Nₚ represents the number of scan lines per frame, and f_{FRAME} represents the frame rate of the LiDAR 1. In this embodiment, the frame rate indicates that the LiDAR 1 customarily packages a plurality of scanning cycles into a data packet for transmission.

The number of lines in the first scan line of the reflective element 21 can be calculated based on a third formula. The number of lines in the first scan line corresponds to the number of horizontal scan lines. Specifically, the third formula is: N=nNₚ. Where, N represents the number of lines in the first scan line of the reflective element 21, and n represents the number of channels of the first multi-channel fiber collimator 13. The number of lines in the second scan line of the reflective element 21 can be calculated based on a fourth formula. Specifically, the fourth formula is:

$${N}_{r} = \frac{{f}_{emit} η}{{N}_{p}} .$$

Wherein, Nᵣ represents the number of lines in the second scan line of the reflective element 21. The number of lines in the second scan line corresponds to the number of vertical scan lines. fₑₘᵢₜ represents the repetition rate of the laser emitter 11, η represents the duty cycle, and fₑₘᵢₜη represents the actual emission repetition rate of the laser emitter 11.

The point cloud array formed by a plurality of first scan lines and a plurality of second scan lines can be expressed as: N pixels×Nᵣ pixels. It can be understood that in the point cloud array, the number of horizontal point clouds is determined by the number of reflective surfaces 210, the second rotational speed, and the number of channels of the first multi-channel collimator 13; the number of vertical point clouds is determined by the repetition rate and duty cycle of the laser emitter 11.

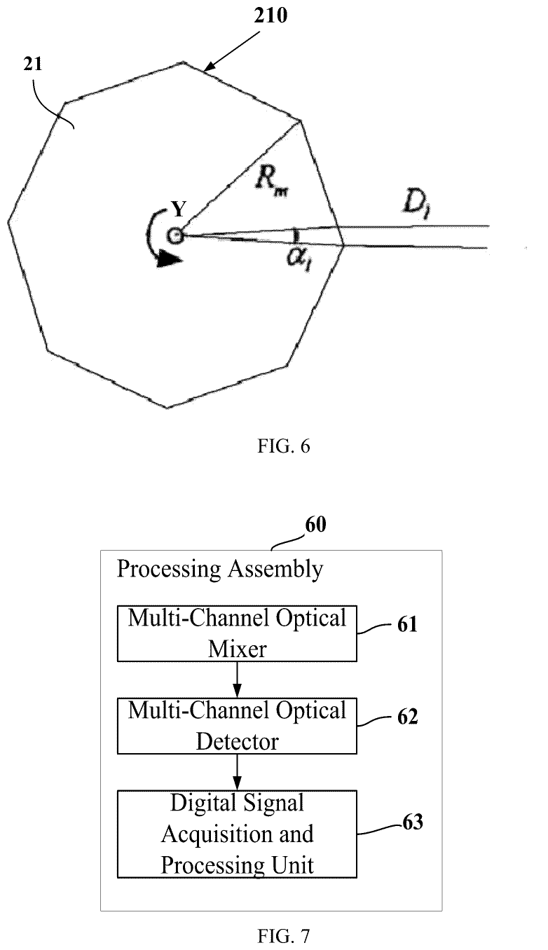

Taking the cross-section of the reflective element 21 shown in FIG. 6 as an example, the inscribed radius of the reflective element 21 is Rₘ, and the width of the light spot formed on the reflective surface 210 by the incident laser beams is Dₗ. Assuming that the width Dₗ is far smaller than the inscribed radius Rₘ, the angle αₗ subtended by the plurality of the laser beams at the central axis of the reflective element 21 can be calculated based on a fifth formula. Specifically, the fifth formula is:

$${α}_{l} = \frac{{D}_{l} \times 180 °}{π {R}_{m}} .$$

The effective rotation angle of each reflective surface 210 can be calculated based on a sixth formula. Specifically, the sixth formula is:

$${α}_{v} = {α}_{n} - {α}_{l} = \frac{360 °}{{N}_{m}} - \frac{{D}_{l} \times 180 °}{π {R}_{m}} .$$

wherein, Nₘ represents the number of reflective surfaces 210, and αₙ represents the angle subtended by the reflective surfaces 210 at the central axis.

The effective field of view (FOV) angle formed θᵥ when the laser beam is reflected by the reflective surface 210 and exits through the window 43, i.e., the vertical FOV angle of the LiDAR 1, can be calculated based on the seventh formula. Specifically, the seventh formula is:

$${θ}_{v} = \frac{720 °}{{N}_{m}} - \frac{{D}_{l} \times 360 °}{π {R}_{m}} .$$

Therefore, the vertical angular resolution of the LiDAR 1 is

$$\frac{{θ}_{v}}{{N}_{r}} .$$

Since the turntable controller 32 controls the turntable 31 to rotate 360°, the horizontal FOV angle of the LiDAR 1 is 360°. Therefore, the horizontal angular resolution of the LiDAR 1 is

$$\frac{360 °}{N} .$$

For example, if the number of Nₘ reflective surfaces 210 of the reflective element 21 is 8, and the second rotational speed of the reflective element 21 is 6000 RPM (i.e., ω̅100 revolutions/second), the scanning frequency f_{scan} is 800 Hz. If the frame rate f_{FRAME} of the LiDAR 1 is 10 Hz, the number of scan lines per frame Nₚ is 80. If the number of channels of the first multi-channel fiber collimator 13 is 3, the number of lines in the first scan line N is 240. If the repetition rate of the laser emitter 11 fₑₘᵢₜ is 200 kHz (i.e., the laser emitter 11 emits 200,000 times per frame) and the duty cycle η is 80%, the laser emitter 11 actually emits 160,000 times per frame, and the number of lines in the second scan line Nᵣ is 2000. Therefore, the point cloud array formed by the first scan lines and the second scan lines is 240 pixels×2000 pixels.

Correspondingly, the horizontal FOV angle is 360°, and the horizontal angular resolution is 1.5°. If the inscribed radius of the reflective element 21 Rₘ is 100 mm, the vertical FOV angle θᵥ is approximately 50°, and the vertical angular resolution is 0.025°.

Referring to FIG. 5, which is a schematic diagram of the internal structure of the reflective assembly provided in this embodiment. The reflective assembly 20 further includes an optical derotator assembly 23 disposed on the optical path 100 between the laser transceiver assembly 10 and the reflective element 21. It can be understood that before the laser beam enters the reflective element 21, it must first pass through the optical derotator assembly 23, which is used for image rotation compensation. The optical derotator assembly 23 can rotate around the first axis X. The rotational speed of the optical derotator assembly 23 around the first axis X is adapted to the rotational speed of the reflective element 21 around the first axis X. In this embodiment, the rotational speed of the optical derotator assembly 23 around the first axis X can be half of the rotational speed of the reflective element 21 around the first axis X. For example, if the first rotational speed is 3600°/second, the rotational speed of the optical derotator assembly 23 is 1800°/second. In some feasible embodiments, the relationship between the rotational speed of the optical derotator assembly 23 around the first axis X and the rotational speed of the reflective element 21 around the first axis X can also be set according to actual conditions, which is not limited herein.

In this embodiment, the optical derotator assembly 23 is a Pechan prism. For example, the optical derotator assembly 23 is made of Schott glass, specifically flint glass material with the model SF11. The refractive index of the optical derotator assembly 23 at the 1550 nm band reaches 1.74, and the two non-totally reflecting surfaces are coated with a 1550 nm high-reflection film. The width of the optical derotator assembly 23 is 15 mm, and the height is 20 mm. In some feasible embodiments, the parameters of the optical derotator assembly 23 can be adjusted according to actual conditions, not limited to this.

The reflective assembly 20 further includes a gear transmission system 24 connected to both the reflective element 21 and the optical derotator assembly 23. When the reflective element 21 rotates around the first axis X, it drives the gear transmission system 24 to operate, which in turn drives the optical derotator assembly 24 to rotate around the first axis X.

The LiDAR 1 further includes a processing component 60. The processing component 60 is housed in the second accommodation cavity 500 and is electrically connected to the laser transceiver assembly 10. The processing component 60 is configured to process the laser beam and the returned beam to generate point cloud data.

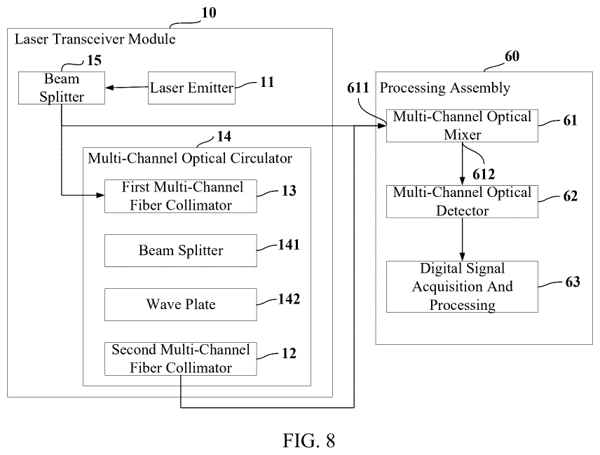

Referring to FIGS. 7 and 8. FIG. 7 is a schematic diagram of the internal structure of the processing component provided in this embodiment, and FIG. 8 is a schematic diagram of the connection relationship between the processing component and the laser transceiver assembly provided in this embodiment. The processing component 60 includes a multi-channel optical mixer 61, a multi-channel optical detector 62, and a digital signal acquisition and processing unit 63 connected in sequence. The multi-channel optical mixer 61 is connected to the multi-channel optical detector 62, and the multi-channel optical detector 62 is connected to the digital signal acquisition and processing unit 63. The multi-channel optical mixer 61 collects the laser beam emitted by the laser emitter 11 and the returned beam received by the second multi-channel fiber collimator 12, and performs coherent mixing of the laser beam and the returned beam to obtain a mixed beam. The multi-channel optical detector 62 converts the mixed beam into corresponding electrical signals. The digital signal acquisition and processing unit 63 is further connected to the self-rotation controller 22 and the turntable controller 32. The digital signal acquisition and processing unit 63 processes the electrical signals and combines data such as the flipping angle of the reflective element 21 fed back by the self-rotation controller 22 and the rotation angle of the turntable 31 fed back by the turntable controller 32 to obtain point cloud data.

In this embodiment, the laser transceiver assembly 10 further includes a beam splitter 15, which is disposed between the laser transmitter 11 and the first multi-channel optical collimator 13. The multi-channel optical mixer 61 includes a receiving end 611 and an output end 612. The receiving end 611 of the multi-channel optical mixer 61 is respectively connected to the beam splitter 15 and the second multi-channel optical collimator 12, and the output end 612 of the multi-channel optical mixer 61 is connected to the multi-channel optical detector 62. It should be understood that the beam splitter 15 divides the original beam emitted by the laser transmitter 11 into two paths. One beam path is directed to the first multi-channel optical collimator 13 to form a plurality of laser beams, and the other beam path is directed to the receiving end 611 of the multi-channel optical detector.

The LiDAR 1 further includes a power supply assembly 70 and a communication assembly 80. The power supply assembly 70 and the communication assembly 80 may be accommodated in the first accommodation chamber 400, may be accommodated in the second accommodation chamber 500, or may be disposed within the connecting neck 90 between the first housing 41 and the second housing 51. In this embodiment, the power supply assembly 70 and the communication assembly 80 are disposed in the connecting neck 90. Herein, the power supply assembly 70 is respectively connected to the communication assembly 80 and the rotation controller 22, and is configured to provide power to the communication assembly 80 and the rotation controller 22. The communication assembly 80 is respectively communicatively connected to the rotation controller 22, the turntable controller 32, and the processing component 60, and is configured to provide data communication. In this embodiment, the power supply assembly 70 is a wireless power supply device, and the communication assembly 80 is a wireless communication device. In some feasible embodiments, the power supply assembly 70 may further be connected to the laser transceiver assembly 10, the control assembly 30, or the processing component 60, and configured to provide power thereto.

In the aforementioned embodiments, through cooperation between the reflective element that can flip around the second axis and the turntable, when the laser beam is incident on the reflective element, the reflective element rotates around the first axis while flipping around the second axis, thereby reflecting the laser beam along the first axis and the second axis to achieve multi-line scanning. When the reflective element is fixed to the turntable and rotates 360° around the first axis while flipping 360° around the second axis, it enables 360° circumferential scanning, thereby forming a 360° point cloud array. Based on the laser beam and the returned optical beam, and synchronously based on the rotation and flipping angles of the reflective element, 360° point cloud data is obtained. The overall structure of the LiDAR breaks through the constraints of conventional multi-line LiDAR upper and lower cabin structural configurations, and is applicable to LiDARs of different types including incoherent and coherent systems. It features small rotational inertia, simple structure, high reliability, ease of integration and miniaturization, and demonstrates promising development prospects in the field of vehicle-mounted LiDAR.

It is apparent that those skilled in the art can make various modifications and variations to the disclosure without departing from the spirit and scope thereof. Therefore, it is intended that such modifications and variations, provided they fall within the scope of the claims of the disclosure and their equivalents, be covered by the disclosure.

The foregoing examples are merely preferred embodiments of the disclosure and are not intended to limit the scope of the claims thereof. Accordingly, equivalent variations made in accordance with the claims of the disclosure still fall within the scope covered by the disclosure.

1. A LiDAR device, comprising:
an upper housing; and
a lower housing, opposite to the upper housing;
a connecting neck, connected between the upper housing and the lower housing; and
an optical path, communicated with the lower housing, the connecting neck, and the upper housing;
wherein a laser transceiver assembly is arranged inside the lower housing, a reflective assembly is arranged inside the upper housing; the reflective assembly comprises a reflector, and a self-rotation controller; the upper housing includes a window; the LiDAR device further comprises a control assembly, the control assembly comprises a turntable controller, and a turntable, the turntable controller is fixed inside the lower housing, one end of the turntable is connected to the turntable controller, and the other end extends into the upper housing for mounting the reflector;
wherein the turntable controller controls the turntable to rotate about a first axis, and the self-rotation controller is configured to drive the reflector to flip about a second axis different from the direction of the first axis, on the turntable, so that the reflector rotating about the first axis simultaneously flips about the second axis;
wherein the laser transceiver assembly is configured to emit a plurality of laser beams parallel in a plane, the plurality of laser beams transmits along the optical path into the reflector in the upper housing, and the plurality of laser beams are reflected by the reflector to exit through the window; after being emitted, the plurality of laser beams form a plurality of reflected beams upon reflection by an object, the reflected beams then return through the window to the reflector, and the plurality of reflected beams are reflected by the reflector to travel back along the optical path to the laser transceiver assembly.

2. The LiDAR device according to claim 1, wherein the window is an annular window.

3. The LiDAR device according to claim 1, wherein the upper housing, the lower housing, and the connecting neck are all in a cylindrical shape, and the central axes of the upper housing, the lower housing, and the connecting neck are all located on the same straight line.

4. The LiDAR device according to claim 1, wherein the LiDAR device further comprises a power supply assembly and a communication assembly, the power supply assembly and the communication assembly are arranged in the connecting neck.

5. The LiDAR device according to claim 1, wherein the reflective assembly further comprises an optical derotator assembly, and a gear transmission system, the optical derotator assembly is arranged on the optical path between the laser transceiver assembly and the reflector; the gear transmission system is connected to the reflector and the optical derotator assembly, and the gear transmission system is configured to drive the optical derotator assembly to rotate about the first axis.

6. The LiDAR device according to claim 1, wherein the reflector is a prism or a pyramid, the second axis is an axis of the reflector, and the reflector comprises a plurality of reflective surfaces, the plurality of reflective surfaces are adjacent to each other around the second axis.

7. The LiDAR device according to claim 1, wherein the laser transceiver assembly comprises a laser transmitter, a beam splitter, and a multi-channel optical circulator, the multi-channel optical circulator comprises a first multi-channel fiber collimator, a second multi-channel fiber collimator, a plurality of beam splitters, and a plurality of wave plates, and a number of channels of the first multi-channel fiber collimator is the same as that of the second multi-channel fiber collimator.

8. The LiDAR device according to claim 7, wherein both the first multi-channel fiber collimator and the second multi-channel fiber collimator are three-channel fiber collimators, the multi-channel optical circulator comprises one polarization beam splitter, two half-wave plates, and one quarter-wave plate, the quarter-wave plate, the polarization beam splitter, one of the half-wave plates, and the first multi-channel fiber collimator are sequentially arranged along the first axis, and the polarization beam splitter, the other half-wave plate, and the second multi-channel fiber collimator are sequentially arranged along a direction perpendicular to the first axis.

9. The LiDAR device according to claim 1, wherein the turntable comprises a rotation shaft, and a rotation disk; the rotation shaft connects the turntable controller and the rotation disk, the rotation shaft is in a shape of a hollow cylinder, the first axis is a central axis of the rotation shaft, and the reflective assembly is arranged on the side of the rotation disk away from the turntable controller.

10. The LiDAR device according to claim 7, wherein the LiDAR device further comprises a processing component, the processing component comprises a multi-channel optical mixer, a multi-channel optical detector, and a digital signal acquisition and processing unit sequentially connected, the multi-channel optical mixer comprises a receiving end and an output end, the receiving end is connected to the beam splitter and the second multi-channel fiber collimator respectively, and the output end is connected to the multi-channel optical detector.

11. LiDAR device, comprising:
an upper housing and a lower housing, opposite to each other;
a connecting neck, connecting the upper housing and the lower housing;
an optical path, extending through the lower housing, connecting neck, and upper housing;
a laser transceiver assembly, disposed in the lower housing;
a reflective assembly, disposed in the upper housing and comprising:
a reflector, and
a self-rotation controller;
a window, formed in the upper housing;
a control assembly, comprising:
a turntable controller, fixed in the lower housing, and
a turntable, with one end connected to the turntable controller and the other end extending into the upper housing to mount the reflector;
wherein:
the turntable controller drives the turntable to rotate about a first axis;
the self-rotation controller drives the reflector to flip about a second axis, distinct from the first axis, while the turntable rotates;
the laser transceiver assembly emits a plurality of planar-parallel laser beams, which travel along the optical path to the reflector, are reflected by the reflector to exit through the window, form reflected beams upon hitting an object, and return via the window and reflector back to the laser transceiver assembly.

12. The LiDAR device according to claim 11, wherein the window is an annular window.

13. The LiDAR device according to claim 11, wherein the upper housing, the lower housing, and the connecting neck are all in a cylindrical shape, and the central axes of the upper housing, the lower housing, and the connecting neck are all located on the same straight line.

14. The LiDAR device according to claim 11, wherein the LiDAR device further comprises a power supply assembly and a communication assembly, the power supply assembly and the communication assembly are arranged in the connecting neck.

15. The LiDAR device according to claim 11, wherein the reflective assembly further comprises an optical derotator assembly, and a gear transmission system, the optical derotator assembly is arranged on the optical path between the laser transceiver assembly and the reflector; the gear transmission system is connected to the reflector and the optical derotator assembly, and the gear transmission system is configured to drive the optical derotator assembly to rotate about the first axis.

16. The LiDAR device according to claim 11, wherein the reflector is a prism or a pyramid, the second axis is an axis of the reflector, and the reflector comprises a plurality of reflective surfaces, the plurality of reflective surfaces are adjacent to each other around the second axis.

17. The LiDAR device according to claim 11, wherein the laser transceiver assembly comprises a laser transmitter, a beam splitter, and a multi-channel optical circulator, the multi-channel optical circulator comprises a first multi-channel fiber collimator, a second multi-channel fiber collimator, a plurality of beam splitters, and a plurality of wave plates, and a number of channels of the first multi-channel fiber collimator is the same as that of the second multi-channel fiber collimator.

18. The LiDAR device according to claim 17, wherein both the first multi-channel fiber collimator and the second multi-channel fiber collimator are three-channel fiber collimators, the multi-channel optical circulator comprises one polarization beam splitter, two half-wave plates, and one quarter-wave plate, the quarter-wave plate, the polarization beam splitter, one of the half-wave plates, and the first multi-channel fiber collimator are sequentially arranged along the first axis, and the polarization beam splitter, the other half-wave plate, and the second multi-channel fiber collimator are sequentially arranged along a direction perpendicular to the first axis.

19. The LiDAR device according to claim 11, wherein the turntable comprises a rotation shaft, and a rotation disk; the rotation shaft connects the turntable controller and the rotation disk, the rotation shaft is in a shape of a hollow cylinder, the first axis is a central axis of the rotation shaft, and the reflective assembly is arranged on the side of the rotation disk away from the turntable controller.

20. The LiDAR device according to claim 17, wherein the LiDAR device further comprises a processing component, the processing component comprises a multi-channel optical mixer, a multi-channel optical detector, and a digital signal acquisition and processing unit sequentially connected, the multi-channel optical mixer comprises a receiving end and an output end, the receiving end is connected to the beam splitter and the second multi-channel fiber collimator respectively, and the output end is connected to the multi-channel optical detector.
